(19) United States
(12) Patent Application Publication
(10) Pub. No.: US 2010/0237005 A1
(43) Pub. Date: Sep. 23, 2010

(54) Filter pad and method of manufacture

(76) Inventor: Nicholas Brentnall, Cheltenham (GB)

Correspondence Address: IRA S. DORMAN, 330 ROBERTS STREET, SUITE 200, EAST HARTFORD, CT, 06108, US

(21) Appl. No.: 12/661,593

(22) Filed: Mar. 19, 2010

(30) Foreign Application Priority Data
Mar. 20, 2009 (GB) 0904768.9

(51) Int. Cl. B01D 39/16; B01D 39/08; B29C 43/02

(52) U.S. Cl. 210/496; 264/324

(57) ABSTRACT

A filter pad comprises a pad (1) of non-woven fibrous material having a peripheral region in which opposing faces have been compressed together and fused so as to form an outwardly-extending peripheral lip (5). The filter pad is manufactured by providing a pad (1) of non-woven fibrous material, and compressing and heating a peripheral region of the pad so as to fuse the material of the pad and to form an outwardly extending peripheral lip (5).

This invention relates to a filter pad of non-woven fibrous material and to a method of manufacturing such a filter pad.

### BACKGROUND TO THE INVENTION

It is common practice to manufacture filters of non-woven fibrous material by encasing peripheral regions of a filter pad in a frame formed around the filter pad by an injection moulding process, there being a seal between the periphery of the filter pad and the frame. The seal ensures that all of the fluid passes through the filter pad without by-passing the pad. The frame also provides support for the filter pad and improves handleability and durability thereof.

### DESCRIPTION OF PRIOR ART

The injection moulding process relies on axial compression of peripheral regions of the filter pad so as to eliminate any lofted non-woven material and to allow the injection moulding tool to seal with the filter pad around the periphery thereof. Compressing the filter pad makes it less permeable and affects its performance, considerably so with relatively thick filter pads (for example having a thickness greater than about 10 mm). On the other hand, if the filter pad is not compressed the injection moulding process will simply inject the plastics frame material throughout the entire filter pad rendering the pad useless. Such a compression technique is known, for example, from WO-A-2005079951.

It is therefore desirable to provide a filter pad and a method of manufacturing such a filter pad which inhibits absorption of frame material beyond the periphery of the filter pad without the need for compressing the peripheral region of the filter pad.

### OBJECT OF THE INVENTION

It is therefore an object of the present invention to provide a filter pad of non-woven fibrous material and a method of manufacturing such a filter pad which overcomes or at least ameliorates the disadvantages of known filter pads.

### SUMMARY OF THE INVENTION

According to one aspect of the present invention there is provided a filter pad comprising a pad of non-woven fibrous material having a peripheral region in which opposing faces have been compressed together and fused so as to form an outwardly-extending peripheral lip.

A transition region may be provided between opposing faces of the filter pad and the peripheral lip in which the surface of the filter pad extends in a substantially axial direction. The surface of the filter pad may be fused in the transition region.

The opposed surfaces of the filter pad may be fused in a further peripheral region of the filter pad located inwardly of the first-mentioned peripheral region.

According to another aspect of the present invention there is provided a method of manufacturing a filter pad comprising the steps of:

providing a pad of non-woven fibrous material; and

compressing and heating a peripheral region of the pad so as to fuse the material of the pad and to form an outwardly extending peripheral lip.

The method may include the further step of forming a transition region between opposing faces of the filter pad and the peripheral lip in which the surface of the filter pad extends in a substantially axial direction. The surface of the filter pad may be fused in the transition region.

The method may include the further step of fusing opposed surfaces of the filter pad in a further peripheral region of the filter pad located inwardly of the first-mentioned peripheral region.

Opposing surfaces of the filter pad may be compressed or configured to determine the configuration of the edge region and/or peripheral surface of the filter pad.

The non-woven fibrous material may comprise a plastics material, such as polyester, polypropylene, nylon 6 or nylon 6/6.

The fibrous material may be heated substantially to its softening point. The softening point may be in the range from 20 to 30 degrees Celsius below the melting point to the melting point. For polyester material the fibrous material may be heated from substantially 235 to substantially 265 degrees Celsius, for polypropylene material the fibrous material may be heated from substantially 145 to substantially 165 degrees Celsius, for nylon 6 material the fibrous material may be heated from substantially 180 to substantially 210 degrees Celsius, and for nylon 6/6 material the fibrous material may be heated from substantially 245 to substantially 255 degrees Celsius.

For a better understanding of the present invention and to show more clearly how it may be carried into effect reference will now be made, by way of example, to the accompanying drawings in which:

### BRIEF DESCRIPTION OF THE DRAWINGS

FIG. 1 is a perspective view of one embodiment of a known filter pad for use in the present invention;

FIG. 2 is a perspective view of one embodiment of a filter pad according to the present invention;

FIG. 3 is a perspective view showing a step in a method of manufacturing a filter pad according to the present invention;

FIG. 4 is a perspective view showing another step in a method of manufacturing a filter pad according to the present invention;

FIG. 5 is a perspective view showing a further step in a method of manufacturing a filter pad according to the present invention; and

FIG. 6 is a cross-section view corresponding to FIG. 5.

### DESCRIPTION OF PREFERRED EMBODIMENTS

FIG. 1 shows a conventional filter pad 1 of circular shape, although the pad could have other shapes. The filter pad 1 is made of a non-woven fibrous material, for example a plastics material such as polyester, polypropylene, nylon 6 or nylon 6/6.

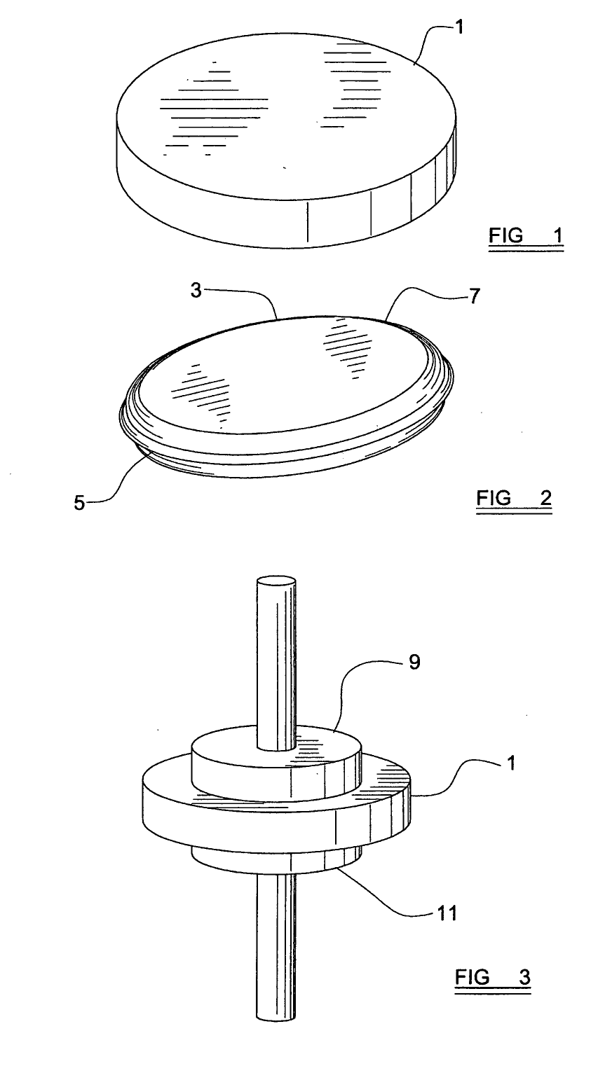

FIG. 2 shows a filter pad 3 according to the present invention which has been compressed around a peripheral region thereof and heated substantially to the softening temperature of the fibrous material so as to fuse together the fibres of the filter pad material in the peripheral portion to form an outwardly protruding lip 5 extending around the periphery of the filter pad. A transition region 7 between the lip 5 and a substantially planar face of the filter pad is abrupt so as to keep to a minimum the width of the peripheral region and to maximise the available surface area of the filter pad and correspondingly to maximise the performance of the resulting filter. The softening temperature may be in the range from 20 to 30 degrees below the melting temperature to the melting temperature of the material. For polyester material the fibrous material may be heated from substantially 235 to substantially 265 degrees Celsius, for polypropylene material the fibrous material may be heated from substantially 145 to substantially 165 degrees Celsius, for nylon 6 material the fibrous material may be heated from substantially 180 to substantially 210 degrees Celsius, and for nylon 6/6 material the fibrous material may be heated from substantially 245 to substantially 255 degrees Celsius.

There is a practical relationship between the time the filter pad is heated, the pressure applied to the pad and the temperature to which the fibres of the filter pad are heated. For example, a lower temperature requires more pressure and/or time, while a higher temperature requires lower pressure and/or shorter time. Such relationship can readily be determined for any particular material by routine tests not requiring any inventive activity.

In order to form a filter incorporating the filter pad according to the present invention, the filter pad 3 can be inserted into an injection moulding tool, or a resin casting mould, which seals against the lip 5 so as to mould a frame, leaving the remainder of the filter pad uncompressed.

The filter pad 3 shown in FIGS. 3 and 6 may be manufactured by an apparatus which comprises means for supporting a pad 1, for example a pair of opposed support plates 9, 11 which are movable towards and away from each other in an axial direction of the filter pad 1 such that, when the plates 9, 11 are moved towards each other they lightly grip the pad 1 without compressing the same, and release the pad when moved away from each other. The support plates 9, 11 are dimensioned to leave a peripheral region of the filter pad 1 exposed.

Two pressure plates 13, 15 are provided, having a respective aperture 17, 19 dimensioned to accommodate a respective support plate 9, 11. The illustrated filter pad 1 is circular, so a circular aperture is required, but the filter pad may have other shapes and a correspondingly shaped aperture should be provided. The lower inner edge of the upper pressure plate 13 and the upper inner edge of the lower pressure plate 15 is formed with an annular recess 21, 23 which is substantially rectangular in cross-section, but with a rounded inner corner, and which engages the peripheral region of the filter pad 1 so as to form the transition region 7 with the extreme peripheral edge of the filter pad being gripped and compressed between opposing planar faces of the pressure plates 13, 15 so as to form the peripheral lip 5.

Each pressure plate 13, 15 is also provided with heating means, such as an electric heating element (not shown) which heats the pressure plate, or at least the region thereof adjacent to the peripheral region of the filter pad 1, to a temperature substantially corresponding to the melting temperature of the fibrous material.

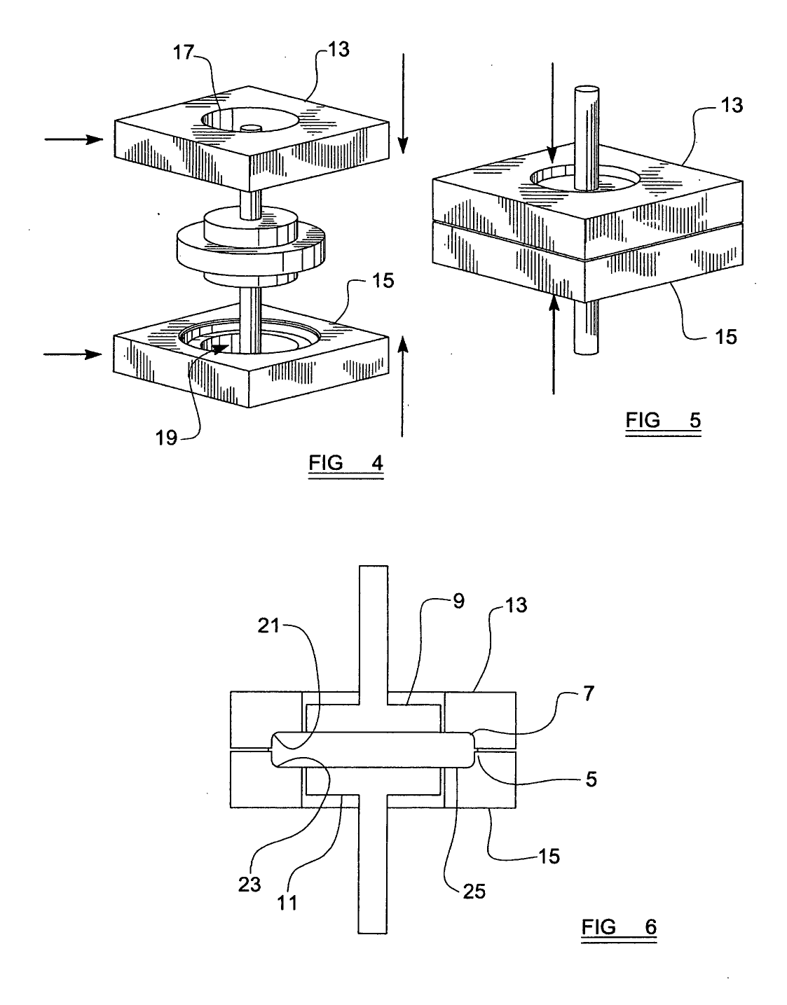

In use of the apparatus shown in FIGS. 3 to 6, the support plates 9, 11 are first moved apart and a filter pad 1 is placed substantially centrally on the lower support plate 9. The support plates are then moved together so as to lightly grip the filter pad 1. Once the filter pad has been lightly gripped, the heated pressure plates 13, 15 are moved together such that the recesses 21, 23 engage the peripheral region of the filter pad 1 while the opposing surfaces of the filter pad are urged towards each other in the peripheral region such that the extreme peripheral edge of the filter pad is compressed between opposing faces of the pressure plates. The heat of the pressure plates causes the fibres in the surface region of the fibrous material to fuse together and movement of the pressure plates 13, 15 towards each other draws down the peripheral region of the pad 1 towards the lip 5, forming the transition region 7 in which the fibres of the fibrous material are also fused together so as to form the filter pad 3 shown in FIGS. 2 and 6. The heated pressure plates 13, 15 also fuse opposed surfaces of the pad 1 in a further peripheral region 25 located radially inwardly of a first peripheral region formed by the lip 5 and the transition region 7.

The fused surface of the filter pad inhibits the entry into the interior of the filter pad 3 of the frame forming material in subsequent injection moulding or resin casting of a frame around the peripheral region of the filter pad 3. In addition, the moulding tool employed in either procedure is able to seal against the fused surface of the filter pad 3 and the escape of frame material between the tool and the filter pad 3 is prevented without the need for compressing the filter pad. Thus, the edge region of the filter pad can readily be over-moulded without degrading and/or compressing the edge of the filter pad and consequently without affecting the overall filter performance, such as dust loading and/or air permeability.

The manner in which the peripheral surface of the filter pad 3 is configured between the heated pressure plates 13, 15 may be adjusted in order to modify the edge region of the resulting filter. For example, the central region of the filter pad 1 may be compressed by the support plates 9, 11 to a degree greater than a light grip. Greater compression in the central region of the filter pad causes the peripheral wall to bulge outwardly and/or the upper and lower surfaces to be concave so that the angle between the top and bottom surfaces and the peripheral wall is other than 90 degrees and affects the configuration of the edge region following manufacture. Alternatively, the peripheral wall and/or the edge region of the top and bottom surfaces of the filter pad 3 may be cut to form an angle other than 90 degrees so as to have a similar effect on the configuration of the edge region following manufacture.

I claim:

1. A filter pad comprising a pad (1) of non-woven fibrous material having a peripheral region in which opposing faces have been compressed together and fused so as to form an outwardly-extending peripheral lip (5).

2. A filter pad as claimed in claim 1, wherein a transition region (7) is provided between opposing faces of the filter pad (1) and the peripheral lip (5) in which the surface of the filter pad extends in a substantially axial direction.

3. A filter pad as claimed in claim 2, wherein the surface of the filter pad (1) is fused in the transition region (7).

4. A filter pad as claimed in claim 1, wherein the opposed surfaces of the filter pad (1) are fused in a further peripheral region (25) of the filter pad located inwardly of the first-mentioned peripheral region.

5. A filter pad as claimed in claim 1, wherein the non-woven fibrous material comprises a plastics material.

6. A filter pad as claimed in claim 5, wherein the non-woven fibrous material is selected from polyester, polypropylene, nylon 6 and nylon 6/6.

7. A method of manufacturing a filter pad comprising the steps of:
providing a pad (1) of non-woven fibrous material; and
compressing and heating a peripheral region of the pad so as to fuse the material of the pad and to form an outwardly extending peripheral lip (5).

8. A method according to claim 7 and including the further step of forming a transition region (7) between opposing faces of the filter pad (1) and the peripheral lip (5) in which the surface of the filter pad extends in a substantially axial direction.

9. A method according to claim 8, wherein the surface of the filter pad (1) is fused in the transition region (7).

10. A method according to claim 7 and including the further step of fusing opposed surfaces of the filter pad (1) in a further peripheral region (25) of the filter pad located inwardly of the first-mentioned peripheral region.

11. A method according to claim 7, wherein opposing surfaces of the filter pad (1) are compressed or configured to determine the configuration of the edge region and/or peripheral surface of the filter pad.

12. A method according to claim 7, wherein the non-woven fibrous material comprises a plastics material.

13. A method according to claim 12, wherein the non-woven fibrous material is selected from polyester, polypropylene, nylon 6 and nylon 6/6.

14. A method according to claim 7, wherein the fibrous material is heated substantially to its softening point.

15. A method according to claim 14, wherein the softening point is in the range from 20 to 30 degrees Celsius below the melting point to the melting point.
